(19) United States
(12) Patent Application Publication
(10) Pub. No.: US 2010/0047370 A1
(43) Pub. Date: Feb. 25, 2010

(54) PHARMACEUTICAL COMPOSITION WITH ANTIFUNGAL ACTIVITY CONTAINING CYMBOPOGON NARDUS, ITS PROCESS, AND USE

(75) Inventors: Selma Franco, Maringa (BR); Terezinha Svidzinski, Maringa (BR); Suzana Ogava, Maringa (BR); Cláudio Novello, Maringa (BR)

Correspondence Address: BIRCH STEWART KOLASCH & BIRCH, PO BOX 747, FALLS CHURCH, VA, 22040-0747, US

(73) Assignees: APSEN FARMACEUTICA S.A., Sao Paulo (BR); UNIVERSIDADE ESTADUAL DE MARINGA, Maringa (BR)

(21) Appl. No.: 12/561,170

(22) Filed: Sep. 16, 2009

Related U.S. Application Data
(63) Continuation-in-part of application No. PCT/BR2008/000073, filed on Mar. 14, 2008.

(30) Foreign Application Priority Data
Mar. 16, 2007 (BR) PI0702622-6

(51) Int. Cl. A01N 65/44; A01N 31/00; A01P 3/00

(52) U.S. Cl. 424/725; 514/724

(57) ABSTRACT

The present invention refers to the application of extracts of Cymbopogon nardus in the preparation of pharmaceutical compositions with antifungal activity and to the process of obtaining the referred to extracts as well as their use as active component of the referred to compositions employed in the treatment of mycoses.

The invention is also with respect to the compositions containing the vegetal extract obtained from the aerial parts of a plant of the Graminae family with antifungal activity. Preferably the vegetal extract is obtained from the leaves of the plant. Even more preferably the plant used is Cymbopogon nardus (L.) Rendle.

This application is a Continuation-in-Part of PCT International Application No. PCT/BR2008/000073 which has an International filing date of Mar. 14, 2008, which in turn claims priority under 35 U.S.C. 119(a)-(d) of Brazilian application PI0702622-6, filed Mar. 16, 2007. The entire contents of all applications listed above are hereby incorporated in their entirety by reference.

### FIELD OF INVENTION

The present invention refers to the application of extracts of Cymbopogon nardus in the preparation of pharmaceutical compositions with antifungal activity and in the process of obtaining the referred to extracts as well as their use as active component of the referred to compositions employed in the treatment of mycoses.

The invention is also with respect to the compositions containing vegetal extract obtained from the aerial parts of a plant of the family of the Graminae with antifungal activity. Preferentially the vegetal extract is obtained from the leaves of the plant. Even more preferentially the plant employed is the Cymbopogon nardus (L.) Rendle.

The invention is with respect also to the use of compositions containing vegetal extracts and/or isolated substances from the vegetal parts of the plant Cymbopogon nardus (L.) Rendle, for the treatment of mycoses (onicomycoses, dermatomycoses and candidiasis vulvovaginal).

### STATE OF THE ART

The dermatomycoses are most common affections that compromise the skin and attachments such as the nails of the hands and feet and hair that can affect the whole population. Although these disorders are not important in relation to the morbidity and mortality, they affect the quality of life of the patient. They have significant clinical consequences due to their infectious nature and, above all aesthetic prejudice which reflects in self-esteem, vanity and social discrimination. It is important to highlight the significant increase of the prevalence of these affections which seem to be a world tendency, the chronic nature and the therapeutic difficulty of these mycoses which are also aggravating factors.

Classically the agents of the dermatomycoses are the dermatophytes: fungi belonging to the three Trichophyton spp species, Microsporum spp and Epidermophytom floccosun. However, yeasts of the Candida spp species, Trichosporon spp and Geotrichum spp and filamentous fungi not dermatophytes like Fusarium spp, Scitalidium spp and Scopulariopsis spp have been diagnosed with certain frequency.

The onicomycoses (OM) are most common affections that compromise the nails of the hands and feet in human beings and can affect everyone indistinctly. The OM have significant clinical consequences due to their infectious nature and above all aesthetic prejudice which reflects in self-esteem, vanity and social discrimination, being significant causes of medical consultations and even of missing work. They represent 20% of the illnesses of the nails and it is one of the most frequent causes of onicopathies in the whole world. The majority of the authors diagnose the dermatophytes as most frequent etiological agents, (80 to 90%), followed by yeasts (5 to 17) and finally non dermatophyte filamentous fungi (2 to 12%).

In function of the fungi remaining restricted to the most external layer of the nail, some authors recommend topical treatment as first choice. The topical treatment is indicated in located infections and of little extension; in cases of failure, drugs of systemic administration must be prescribed. Nevertheless, the systemic treatment is more effective above all for the chronic infections.

The treatment of onicomycoses continues to be a problem in spite of the undeniable advances in the development of new antifungal agents.

Another infection of fungal origin of great relevance is candidiasis vulvovaginal (CVV) also known as vaginal moniliasis, which is an inflammation of the genital mucous which principally compromises the vulva and vagina. The etiological agent most common is Candida albicans, a yeast that presents dimorphic characteristics and can be found in 20% of healthy and asymptomatic women. The principal symptoms that characterize CVV are itching and vulva-vaginal erythema, white and thick discharge with caseose aspect, burning in urination (disury), pain in sexual relations (disparunia), edema e fissures in the vulva region (Garcia & Svidzinski, 2002). The diagnosis of this infection can be established by the characteristic symptoms, by the vaginal pH which in the range of normality is found between 4 and 4.5, by the aspect and odor of the secretion and by the identification of yeasts and hyphae in the microbiological examination (Daniel & Robinson, 2005).

It is amongst the principal gynecological problems that affect women in productive age reaching thousands of persons in the whole world, its prevalence seems to have increased in the last few years. It is estimated that close on 75% of the adult women present at least one episode of fungal vulva-vaginitis in their life being that of these, 40 to 50% experienced new outbreaks and 5% become recurrent (CVVR). 80 to 90% of the cases of CVV are due to the Candida albicans species and 10 to 20% to other species called C. non-albicans (C. tropicalis, C. glabrata, C. krusei, C. parapsilosis). However an increase in the frequency of isolation of yeasts non-C. albicans in some populations has been observed. The major preoccupation resides in the fact that these other species in general tend to be more resistance to the antifungals.

The resistance of the pathogens in face of the usual therapeutic agents has increased in the last years. Currently drugs are available such as Terbinafine and the azolic derivates effective in the classic treatment of the onicomycoses, however with excessive cost, turning the therapeutic choice and its success limiting.

CVV is one of the most frequent diagnoses in the daily practice of gynecology and has increased in the last few years, however the treatment is still reason for worry of doctors and patients, principally in function of the symptoms and the recurrence.

The treatment of CVV depends on variables relating to the agent, to the host and apparently to environmental factors. The therapeutics available include medicaments of topical use (nistatine and miconazol) and oral, principally the azolic derivates such as fluconazol, itraconazol and cetoconazol.

In spite of the progress observed in the last decades in the development of new antifungals for the treatment of CVV, it still represents a significant problem. The best options available currently are limited and represent treatment of high cost to the patient.

Trichomoniasis, also called as vaginitis by Trichomonas vaginalis is a disease sexually transmitted caused by a protozoan, unicelullar microscopic called Trichomonas vaginalis. Infectious disease of the men genitourinary system and woman genitourinary tract. In the man it causes urethritis with demonstrations in general discreet (ardor and/or itch urethral and secretion white, yellowish or greenish yellow), being able to, eventually to be absentees in some and very intense in other. It is one of the main vaginitis causes or the adult woman's vulvovaginitis being able to however, to pass with little or any clinical demonstration.

When present, is revealed in the woman as a yellow greenish or grayish vaginal discharge, foamy and with strong characteristic odor. It is not uncommon also to happen irritation in the genital region as well as symptoms miccionais that can simulate a cystitis (pain when urinating and frequent urinations), the symptoms can be worse during the menstrual period. Trichomonas vaginalis causes inflammation of the vagina, of the urethra and lap of the uterus, in pregnant women, the infections for the Trichomonas vaginalis can also increase the risk of premature rupture of the membranes and childbirth pre-term.

The World Organization of the Health (OMS) esteems in 170 million the cases of trichomoniasis in the world annually in people between 15 and 49 years, with most happening (92%) in women. The impact of the trichomoniasis is not limited to vaginitises or urethritis, because other pathogenic microorganisms as micoplasmas and Neisseria gonorrhoeae are phagocyted for Trichomonas vaginalis, and segments of viral RNA have been found in certain lineages of the parasite, therefore, it is possible, that this protozoan can also act as vector for other pathogens.

In the chronic infection, the symptoms are light, with scarce vaginal secretion. That form is particularly important of the epidemic point of view, because those individuals are the largest source of transmission of the parasite.

The treatment of the trichomoniasis is specific, the oral metronidazole or others derived nitroimidazoles (tinidazole, nimorazole, secnidazole, carnidazole). To prevent the reverse-infection, a person's sexual partner infected with Trichomonas vaginalis should be treated also. Although the infection for T. vaginalis is common among the pregnant, the metronidazole should not be used by pregnant women during the first quarter and there are no reports of use of natural products for treatment of the trichomoniasis. Besides, there are neonates' reports with “vaginal discharge” infected by T. vaginalis and this microorganism has been observed in cultures of having aspirated tracheal in children with breathing illness as pneumonia.

Innumerable are the researches done in search of compounds with biological activities from natural products. A considerable number of studies have been done to evaluate the evolution of anti-microbial activities in extracts and essential oils from medicinal plants. Many plants are resistant to different pathogens and this resistance can be related to the presence of fungistatic compounds naturally produced.

The search for therapeutic alternatives directed to the phytotherapies passes through the knowledge of the vegetal drug to be used, by the optimization of the extract, by the obtaining of pharmaceutical forms adequate for the treatment and with the necessary quality to obtain the efficiency in the treatment. Allied to these requirements there is also the need for validation of the analytical technique and standardizing of the vegetal extract.

There exists an enormous diffusion and popularity of the therapies of vegetal origin in the whole world, which are, in general, much less onerous and are indicated as complementary in the health services. They can be the first choice for diverse affections before resorting to other more aggressive medicaments.

The medicinal plants produce a variety of components with innumerable properties that can inhibit the growth of pathogens or kill them and for this they are considered optimum options for the development of new anti-microbial drugs.

The species Cymbopogon nardus (L.) Rendle, popularly known as citronella, is a plant of the Graminae family, common in tropical or subtropical climates, it is original from Ceylon and south of India and its essential oil, rich in citronella, isopulegol and geraniol is popularly used as an insect repellent and disinfectant

The repellent activity against insects of the Cymbopogon nardus has been widely disclosed and is associated to the presence of the essential oils: citronella and isopulegol. Recently the action of Cymbopogon nardus over the Aedes aegypti associated with D-trans-aletrine was proved, with mortality of the insect of close on 88.9% when the concentration of 0.1% of the volatile oil was used.

Examples relating to the insecticide activity of Cymbopogon nardus, separately or in associations of the state of the art can be seen in the Brazilian patent document PI9106328-0, which is with respect to an insect repellant in the form of a spray or lotion, containing turpeniol, citronella, extract of rodenol and geraniol, which are synergistically effective against ticks that transmit the Lyme disease as well as insects that sting and triatomas (Chagas insects).

In the same way the PI9610350-7 refers to an insect repellant mixture that contains mentanodiol and at least two selected components of citronella, geraniol, terpineol and rodinol, useful for repelling mosquitoes and ticks.

Also preliminary studies made with plants of the Graminae family have demonstrated important fungicidal activity over fungi coming from diverse types of infections in human beings.

The antifungal activity in vitro of the essential oil of C. nardus or of other species of the Cymbopogon genus over fungi of medical interest have been reported by various authors

From such studies, however, there are no reports proving the identification of similar activity in the extract of Cymbopogon nardus, as well as the existence of phytotherapeutic compositions as much as the use of them in the treatment of onychomycosis, candidiasis vulvovaginal and trichomoniasis.

The use of such extracts would much facilitate the process of obtaining the phytotherapeutic pharmaceutical product, would significantly reduce the cost of the referred to product and would facilitate the incorporation of the active principle in different pharmaceutical forms.

Thus it is that the search for new compounds biologically active obtained from natural products, principally of vegetal origin has become the object of great interest due to the need for new drugs effective in the combat of innumerable diseases.

With relation to the anti-parasitic activity of citronella, the PI0106192-5 claims a phytotherapeutic product based on citronella oil which presents great effectiveness in the general therapy and prophylaxis for endo and ectoparasites which attack bovines, ovines, caprines and equines in general.

With relation to the antimicrobial activity, PI9804814 is also known which describes compositions of oral hygiene that include an antimicrobial agent selected from: cedar oil, cloranfenicol, lemon grass oil, citronella oil, extract of Glycyrrhizin glabra, basilicão fruit oil with juice, basilicão oil (Ocimum sp), of lemon and oil of Rosmarinus officinalis.

The PI0106903-9 refers to pharmaceutical compositions for the treatment of oral and vaginal candidiase covering 1 to 5% in weight of hydro-alcoholic, alcoholic and ethereal extracts and/or essential oils of the aerial parts of Cymbopogon citratus stapf (gramineae) separately or in mixtures of different proportions amongst themselves or with other natural or synthetic products (drugs, vitamins, salt, sugar, etc). The pharmaceutical preparations can be presented in the form of tinctures, emulsions A/O and O/A, creams, gels, aerosols, pastes, soaps, shampoos and similar for topical use in the treatment of infections caused by fungi and bacteria, especially oral and vaginal candidiase.

The PI0203521-9 considers pharmaceutical compositions caused by Candida spp and dermatofite fungi, such as: Epidermophyton floccusum, Microsporum canis and trichophyton rubrum, which contain an active pharmacological quantity of volatile oil of Cymbopogon citratus (lemon grass). In the said compositions the volatile oil was extracted from leaves of lemon grass for distillation by steam stripping, having as principal components citral (60 to 80′ v/v), mircene and geraniol.

Patent JP7061918 reveals a cosmetic product containing at least an extract selected from Vetiveria zizanoides, Hemidesmus indicus, Cymbopogon nardus, Piper longum, Piper chaba, Herpestris monnies, Cardiospermum halicacabum, Tinospora cordifolia, Desmodium gangeticum, Michelia champaca and Melaleuca leucadendroncom, with strong antioxidant action and capable of keeping the skin without cracks and with glow.

One also sees that from the state of the technique, the use of volatile oil extracted from Cymbopogon nardus with repellant activity against insects, sanitizing and disinfecting products as well as about the species Cymbopogon citratus (lemon grass) is known, both about the antimicrobial pharmacological effectiveness against Candida spp and dermatophyte fungi. However none of the documents previously pointed out refer or suggest compositions containing extracts of the plant Cymbopogon nardus with activity against dermatophyte fungi and against Candida albicans.

Therefore, the state of the technique did not describe or suggest the use of extracts of Cymbopogon nardus as antifungal and trichomonicid.

As one sees, the treatment of the onychomycosis, dermatomycosis and candidiasis continues to be a problem in spite of the undeniable advances achieved in the development of new antifungal agents. Therefore the use of products of vegetal origin with fungicidal properties can bring great benefits to the combat of onychomycosis, candidiasis vulvovaginal and dermatomycosis, which has still not been explored.

Thus, as the Cymbopogon nardus is a plant that is also born and grows easily in all the regions of Brazil, without special requirements for cultivation, its extract can therefore be obtained with quite low production cost. Apart from this the obtaining of its extract shows good yield and its incorporation in pharmaceutical forms is quite viable, presenting facility of industrialization of the substitutes of the leaves and stalks of this plant. The biological and trichomonicid results of the present invention show high antifungal activity causing the death of the microorganisms tested (fungicide) and trichomonicid, important advantage over the majority of the antifungals available in the market which are in their great majority only fungistatics and, still, when they are fungicidal, are not effective on Trichomonas vaginalis.

In spite of the existence of compositions and medicaments obtained by extracts from plants reported in the literature, no mention or suggestion was seen as to the use or the phytotherapeutic compositions containing alcoholic and standardized extracts of Cymbopogon nardus, as well as the process of extraction of them, with antifungal and trichomonicid activities. Such process of extraction, phytotherapeutic compositions and the use of them are found described and claimed here in the present application.

### SUMMARY OF THE INVENTION

The invention foresees a pharmaceutical composition adequate to treat onychomycosis and candidiasis vulvovaginal and trichomoniasis, which employs a pharmacologically active quantity of hydro-alcoholic and dry extracts of Cymbopogon nardus, apart from pharmaceutically acceptable excipients.

The present invention additionally covers a process of obtaining hydro-alcoholic extracts, dry extracts and standardized of a plant of the family of Gramineas, more particularly hydro-alcoholic and dry extracts of Cymbopogon nardus.

Also the present invention involves the use of a composition containing vegetal extract obtained from the aerial parts of a plant of the Gramínea family, more particularly Cymbopogon nardus, with antifungal activity for onicomycosis, against dermatophyte fungi and candidiasis as well as with trichomonicid activity against trichomoniasis.

### BRIEF DESCRIPTION OF THE FIGURES

In order to better demonstrate the reach of the invention diverse illustrative figures of the activities and properties identified both in the plant used in the present invention—Cymbopogon nardus, and in the extract obtained from it are presented ahead, in which:

FIG. 1 illustrates the distribution of the values of minimum inhibiting concentration (mg/ml) of extract of C. nardus for index of inhibition of 100% in isolates of dermatophytes and yeasts.

FIG. 2 illustrates the minimum fungicidal concentration (mg/ml) of extract of C. nardus capable of killing 100% of the isolates of dermatophytes and yeasts.

FIG. 3 illustrates the methodology of analysis of the antifungal activity of the C. nardus.

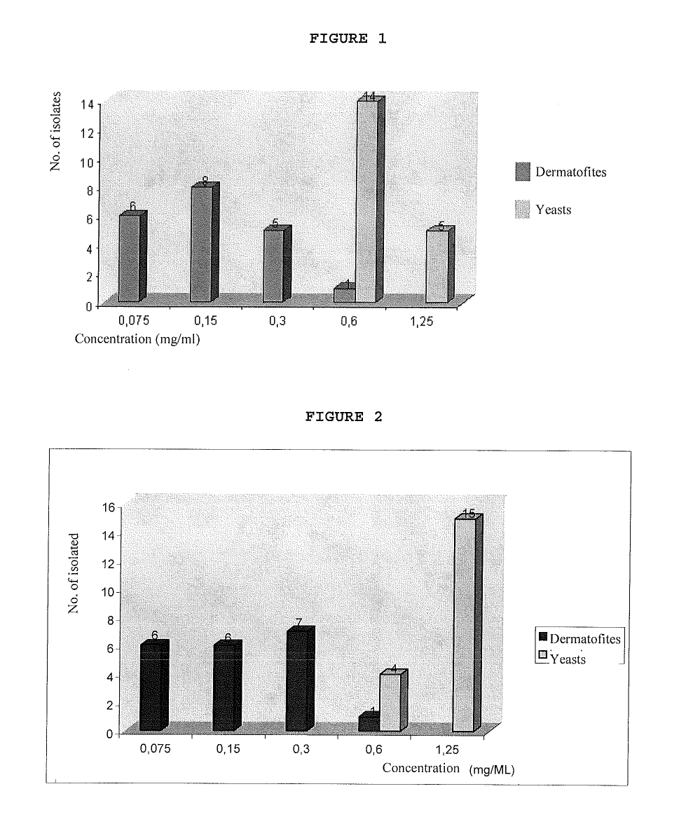

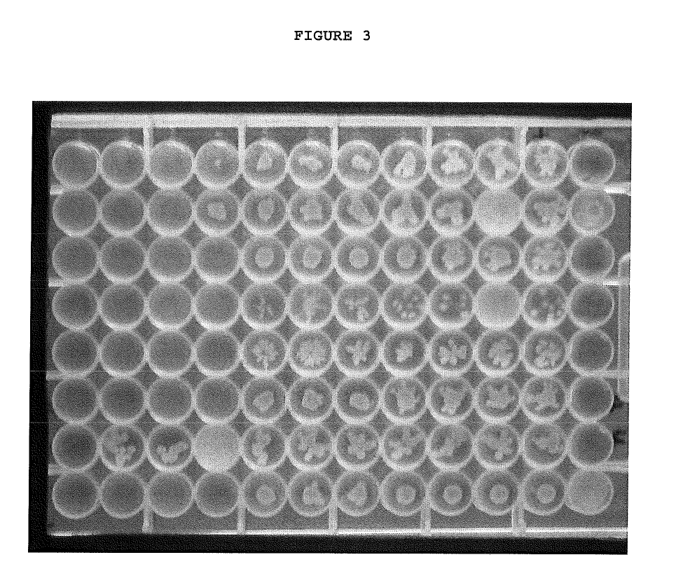

### DETAILED DESCRIPTION OF THE INVENTION

The first aspect is that the invention deals with a pharmaceutical composition directed to the treatment of onychomycosis, dermatomycosis and candidiasis, containing hydro-alcoholic extracts of Cymbopogon nardus.

The pharmaceutical compositions of the present invention can contain hydro-alcoholic extracts of Cymbopogon nardus in concentrations varying from 5 to 40% (p/p).

More preferably the pharmaceutical compositions can contain hydro-alcoholic extracts of Cymbopogon nardus in a range of concentration from 10 to 30% (p/p).

Pharmaceutical excipients are used adequate for the pharmaceutical form chosen for each one of the affections to be treated.

A liquid form of the pharmaceutical composition uses hydro-alcoholic solvents from C1 to C10 atoms of carbon, such as for example: ethanol and dipropylene glycol. The dipropylene glycol can be used in the proportion from 0.1 to 20 ml to each 10 mg of the dry extract, more preferably that each 1 ml contain 10 mg of Cymbopogon nardus dry extract. The ethanol is used diluted in water in the range from 20 to 96% (v/v), preferably used in the dilution of 50% (v/v) in water, and it can contain Cymbopogon nardus dry extract in the range of 0.1 to 30%, more preferably 1:10.

Additionally the invention also deals with a process of hydro-alcoholic extracts of the aerial parts of a plant of the Graminae family, such as, preferably, Cymbopogon nardus.

The process of obtaining of extracts of Cymbopogon nardus starts from the process of vegetal extraction with the employment of physical procedures for the breaking down of the vegetal tissues in the presence of an organic solvent that will make the extraction of a liquid consisting of the gross vegetal extract of the aerial parts of a plant of the Graminae family.

For the obtaining of the extract preferably are used the leaves of the plant Cymbopogon nardus; the physical procedures employed for the breaking down of the vegetal parts used for the turbo-extraction and the organic solvent used can be an alcohol containing between 2 and 6 atoms of carbon, such as ethanol, isopropanol, butanol and pentanol. Even more preferably the turbo-extraction is the physical process chosen and the organic solvent is ethanol. The ethanol can be used in different dilutions however the alcohol is preferably used at 50, 70 and 94.6% (weight/weight).

The gross vegetal extract is then concentrated by the partial removal of the organic solvent. The concentration of the extract occurs by evaporation under controlled temperature and pressure conditions, in a temperature range of 35-55° C. and under reduced pressure (vacuum).

Preferably a rotating evaporator can be used under sufficient temperature to generate the evaporation of the organic solvent used. The gross vegetal concentrated extract of the leaves was then lyophilized. The following stage consists of the evaluation as to the technological parameters and fungicidal and trichomonicid therapeutic activities.

The evaluation of the antifungal activity in vitro of the extracts of C. nardus over agents of onychomycosis was determined through the determination of the Minimum Inhibiting Concentration (CIM) and of the Minimum Fungicidal Concentration (CFM).

The Minimum Inhibiting Concentration (CIM) was determined by the method of micro-dilution in juice, following the norms of standardization proclaimed by the National Committee for Clinical Laboratory Standards published in document M-27A10 with some modifications.

The test was done in sterilized plastic micro-plaques (Nunclon, Delta, Nunc A/S, Roskilde, Denmark) containing 96 wells organized in eight series identified from A to H, each one with twelve wells numbered from 1 to 12. Each line (A-H) corresponded to a fungal species which received 100 μl of the inoculate determined and each column received the extract of C. nardus, diluted in a series way in the proportion of 2 in YNBG juice up to the dilution of 1/128. On each plaque negative, positive controls and a yeast of reference Candida parapsilosis (ATCC 22019) were included. The concentration of inoculate was adjusted in spectrophotometer (Baush&Lomb) to correspond to the turbidity of the tube 0.5 of the Mac Farland scale in wavelength of 530 nm so that the volume of 100 ml of this suspension, added to each well of the plaque contained between 0.5 and 2.5×103 UFC/ml. The plaques thus assembled were incubated in a sterilizer at 35° C. for 48 h with daily monitoring, in the case of yeasts and incubated at ambient temperature for seven days in the case of the dermatophytes. After the adequate incubation time for each fungus, reading of the test was taken through visual comparison by reflection in mirror.

The CIM was considered the least concentration of the liophilized extract of C. nardus capable of inhibiting 100% the growth of each fungal isolate, having as reference its respective positive control (FIG. 3). For the determination of the CFM, aliquots of the cultivations which did not present growth in the test for determination of the CIM, were transferred to a Sabouraud Dextrose Agar medium against the medium exempt of drug. The least concentration that prevented the growth of the fungi was considered the CFM.

The present invention also provides the use of pharmaceutical compositions containing hydro-alcoholic extracts of Cymbopogon nardus for the inhibition of the growth or death of dermatophyte fungi such as: Trichophyton spp, Microsporum spp and Epidermophytom floccosun, as well as affections caused by yeasts such as Candidas, and conditions caused by protozoa, just as Trichomonas vaginalis.

Determination of the Minimum Inhibitory Concentration (CIM) for Trichomonas vaginalis.

They were prepared previous cultures of Trichomonas vaginalis with growth of 48 h in TYM medium (Trypticase-Yeast extract-maltose). After the growth, the tubes were centrifuged for the separation of the protozoa of the culture medium. With Trichomonas, the inoculant was prepared, containing from 1.0×10⁵ to 5.0×10⁵ trophozoites/ml, counted with aid of Neubauer Chamber.

The CIM was determined by the method of micro-dilution in juice using a liquid nutrient medium, 1.5 ml of medium was distributed in 11 hemolysis tubes. A first tube didn't receive culture medium. In the sequence, it was put in the first and second tubes, 1.5 ml of the Cymbopogon nardus extract and, starting from the second tube, they were made serial dilutions until the tenth tube. After the preparation of the dilutions 1.5 ml of Trichomonas vaginalis inoculant already standardized was added. The tubes were incubated to 35° C. by 24 h.

After the incubation, brackets of the liquid were removed and accomplished the count of the alive trophozoites in the Neubauer Chamber. CIM was considered as, the dilution in that didn't remain trophozoites alive. The eleventh tube was the negative control because it only received culture medium. The twelfth was the positive control because didn't receive the extract, just the culture medium plus the inoculant.

For the Trichomonas vaginalis, CIM was considered the smallest C. nardus lyophilized extract concentration capable to inhibit 100% the growth of each isolated of the parasite, tends as reference its respective positive control.

The pharmaceutical preparation can be presented in form of tincture, lotions, gels, ointments, creams, vaginal ovals and tablets for topical use; or tincture, granulates, capsules and tablets for oral use.

For better comprehension of the objects claimed, illustrative examples follow ahead which must not be considered delimiting of the rights of the applicant.

Example of one pharmaceutical composition preferred for each one of the fungal affections affected by the invention can contain at least a quantity of 1250 μg/ml of alcoholic extracts of Cymbopogon nardus for yeasts of onychomycosis; at least 625 μg/ml of alcoholic extracts of Cymbopogon nardus for dermatofites and at least 625 μg/ml of alcoholic extracts of Cymbopogon nardus to inhibit vaginal yeasts (Candida albicans) and at least 625 μg/ml of Cymbopogon nardus dry extract to inhibit vaginal protozoa (Trichomonas vaginalis), apart from excipients and/or diluents, eluents and other acceptable pharmaceutical adjuvants.

### Obtaining of the Extracts Cymbopogon Nardus

### Example 1 A

### Collecting of the Botanical Material to Start

The leaves of C. nardus were collected for use as start material of the extracts to be used in the compositions of the present invention, in the medicinal plant nursery of the State University of Maringá (UEM), during the month of May of 2005. The plant was identified by botanical analysis and confirmed by gaseous chromatography coupled to the mass spectrometry. An exsiccate of the species was deposited in the herbarium of UEM under no. 11747.

### Example 1 B

### Characterization of Technological Parameters for the Vegetal Start Material

Technological parameters were established for the vegetal material Cymbopogon nardus (n=3) such as: loss by drying (PS), loss by desiccation (PD), tenor of total flavinoids (FT), tenor of total Polyphenols (PT) and tenor of volatile oils (OV). The results are contained in Table 1.

TABLE 1
Values obtained of total flavinoids (FT), total Polyphenols
(PT), Volatile oils (OV) loss by dessication (PD) and Loss by
Drying (PS) for the start material C. nardus (n = 3).

| Parameters | Average | s | CV % |
|---|---|---|---|
| FT (%) | 0.30 | 0.0092 | 3.10 |
| PT (%) | 2.35 | 0.12659 | 5.38 |
| PD (%) | 10.57 | 0.2591 | 2.45 |
| OV (%) | 1.82 | 0.4531 | 24.85 |
| PS (%) | 30.59 | 0.1202 | 0.39 |

### Example 1.C

### Preparation of the Extracts

The fresh leaves of C. nardus were cleaned with compressed air, cut in small pieces and submitted to the turbo-extraction for 15 minutes with 70% (p/p) alcohol in the proportion of 20% (p/p) in relation to the dry extract of Cymbopogon nardus (n=3). The extract was filtered, concentrated in a rotary evaporator and later lyophylized. Technological parameters were established in these extracts before the drying, such as: dry residual (RS) and p pH and after drying, the tenors of total flavinoids (FT), total Polyphenols (PT), and antifungal activity were obtained. The results are contained in Table 2.

TABLE 2
Values of pH, dry residual (RS), total Flavinoids (FT)
and total Polyphenols obtained (PT) from the extracts of
C. nardus, dry leaves (n = 3).

| Parameters | Average | s | CV % |
|---|---|---|---|
| FT (%) | 0.85 | 0.0260 | 3.04 |
| PT (%) | 10.87 | 0.2082 | 1.92 |
| RS (%) | 1.98 | 0.0299 | 1.58 |
| pH | 6.02 | 0.0635 | 1.06 |

### Example 2

### Analysis for the Determination of the Biological Activity

For the determination of the antifungal activity of the extract of Cymbopogon nardus in face of the different fungal isolates of clinical origin, the detailed methodology ahead was used.

The fungi were reactivated in Sabouraud Dextrose Agar (SDA) culture medium for 24/48 h at 30° C., from this growth an inoculate was prepared in sterile saline, adjusting the cellular density by means of Bauch & Lomb spectrophotometer in 530 nm with 90+/−2% of transmittance. This turvation resulted in 1.0 to 5.0×10⁶ ufc/ml from which new dilutions were prepared in Yeast Nitrogen base glucose (YNBG) to obtain the final inoculate desired between 0.5 to 2.5×10³ ufc/ml.

The minimum inhibitory concentration (CIM) was determined by the method of micro-dilution in juice, following the norms of standardization proclaimed by the NATIONAL COMMITTEE FOR CLINICAL LABORATORY STANDARDS (INCCLS, 1997) published in document M-27A.

The test was done in sterilized plastic plaques (Nunclon, Delta, Nunc A/S, Roskilde, Denmark) containing 96 wells organized in eight series identified from A to H, each one with twelve wells numbered from 1 to 12. Each line (A-H) corresponded to a fungal isolate (100 μl of the inoculate determined) and each column received the extract of C. nardus, diluted in a series way in the proportion of 2 in YNBG juice up to the dilution 1/1024 which corresponds to the final concentration of 9 μg/ml In each plaque negative and positive controls of the diluent and a yeast of reference Candida parapsilosis (ATCC 22019) were included.

The plaques thus assembled were incubated in a sterilizer at 35° C. for 72 h with daily monitoring After 72 hs reading of the test was taken through visual comparison by reflection in mirror. The CIM was considered the least concentration of the dry extract of C. nardus capable of inhibiting 100% of the growth of each yeast, having its respective positive control as reference. For the determination of the minimum fungicidal concentration (CFM) of the C. nardus aliquots from the wells of the CIM were transferred, where growth was not observed, for comparison with the culture medium free from drug. The least dilution that impeded the growth of the yeasts was considered the CFM.

For the analysis of the results of the minimum fungicidal inhibitory concentrations and minimum fungicidals (CIMs) and (CFMs) obtained through the method chosen were analyzed:

a) variation of the values representing the limits: lower and upper of the CIMs and CFMs of the extract of C. nardus, referent to the different species of yeasts tested.

b) CIM₅₀ and CIM₉₀ defined as the minimum inhibitory concentration of the extract of C. nardus capable of inhibiting the growth of 50% and 90% of the samples tested respectively.

c) CFM₅₀ and CFM₉₀ defined as the minimum fungicidal concentration of extract of C. nardus capable of preventing growth of 50% and 90% of the samples tested respectively.

### Example 2.1

### Facing the Yeasts in Onicomycoses

19 yeasts isolated from the nails of the hands and the feet of ambulatory patients were used. The yeasts causers of onicomycoses cover the species: Candida albicans, C. tropicalis, C. glabrata and C. parapsilosis.

The results show that the minimum inhibitory concentration used in the ratio of 10 mg of the extract of C. nardus to 1 mg of diluent, varied from 0.6-1.25 mg/ml of the total liquid medium. The values of the CFM were identical to those of the CIM, presenting the same behavior in all the species, according to Table 3.

TABLE 3
Variation of the Minimum inhibitory concentration
(CIM) and Minimum fungicidal concentration (CFM) in
mg/ml of the extract of C. nardus over Yeasts.

| | | | CIM - | CFM - |
|---|---|---|---|---|
| | | | Interval | Interval |
| Yeasts | % | N | mg/ml | mg/ml |
| C. albicans | 42.1 | 08 | 0.6-1.25 | 0.6-1.25 |
| C. glabrata | 5.2 | 01 | 0.6 | 0.6 |
| C. parapsilosis | 31.6 | 06 | 0.6 | 0.6 |
| C. tropicalis | 21.1 | 04 | 1.25 | 1.25 |
| TOTAL | 100.0 | 19 | | |

### Example 2.2

### In Face of the Dermatofite Fungi in Onicomycoses

20 dermatophyte fungi isolated from the nails of the hands and feet of ambulatory patients were used. The fungi causers of onicomycoses cover the species: Trichophyton mentagrophytes, T. tonsurans T. raubitscheki, Microsporum canis, M. gypseum, M. ferrugineum.

The results contained in Table 4 show an antifungal potential from the extract of C. nardus for the dermatofites and the values of the CMIs oscillated between 0.075 and 0.6 mg/ml. The action of the extract showed itself to be fungicidal for all the dermatofites with the identical variation of the CMI, 0.075 to 0.6 mg/ml. The dermatofites most sensitive to the extract of C. nardus were the M. canis and the T. tonsurans, with 0.075 mg/ml. T. tonsurans presented the greatest index of variation of CIM and CFM, with 0.075 and 0.6 mg/ml. The other dermatofites presented very little variation for CMI (M. canis, M. Gypseum and T. mentagrophytes) or no variation (M. ferrugineum and T. raubistscheki)

TABLE 4
Variation of the Minimum inhibitory concentration (CIM)
and Minimum fungicidal concentration (CFM) in mg/ml of
the extract of C. nardus over dermatofites

| | | | MIC - | MFC - |
|---|---|---|---|---|
| | | | Interval | Interval |
| Dermatophytes | % | N | (mg/ML) | (mg/ML) |
| Mycrosporum canis | 25 | 05 | 0.075-0.15 | 0.075-0.3 |
| Mycrosporum ferrugineum | 5 | 01 | 0.15 | 0.15 |
| Mycrosporum gypseum | 10 | 02 | 0.15-0.3 | 0.3 |
| Trichosporum mentagrophytes | 20 | 04 | 0.15-0.3 | 0.15-0.3 |
| Trichosporum raubistscheki | 15 | 03 | 0.3 | 0.3 |
| Trichosporum tonsurans | 25 | 05 | 0.075-0.6 | 0.075-0.6 |
| Total | 100 | 20 | | |

### Example 2.3

### In Face of Yeasts in Candidiase Vulvovaginal

23 vulva-vaginal isolates of Candida albicans from ambulatory patients were used.

The results of Table 5 show that the minimum inhibitory concentration of the extract of C. nardus varied from 0.018 to 0.62 mg/ml, according to the data contained in Table 6. The values of the CFM were identical to those of the CIM, presenting the same behavior for all the yeasts.

Thus when we submit in diverse concentrations in face of the 19 yeasts from patients with onicomycose, 20 dermatofites and 23 vaginal yeasts and 1 standard sample (ATCC) to obtain the CIM and CFM of the extract, it was possible to note that the extract of C. nardus in the range of 0.018 to 1.25 mg/ml was capable of inhibiting the totality of fungi tested.

TABLE 5
Variation of the Minimum inhibitory concentration (CIM) and
Minimum fungicidal concentration (CFM) in mg/ml of the extract
of C. nardus over vaginal isolates of Candida albicans

| | | Minimum inhibitory concentration of the | | | | | | | | | |
|---|---|---|---|---|---|---|---|---|---|---|---|
| | | Extract of C. nardus (mg/ml) | | | | | | | | | |
| Fungus | N | 5.0 | 2.5 | 1.25 | 0.62 | 0.31 | 0.15 | 0.075 | 0.036 | 0.018 | 0.009 |
| C. albicans | 23 | | | | 08 | 1 | 3 | 1 | 7 | 3 | + |

According to the results of the biological activity these prove that the extract of C. nardus presents excellent performance in tests in vitro in face of isolated fungi of human clinical situations. And that this activity is not only fungistatic but also fungicidal, even in small concentrations and does not suffer alteration in function of the extractor liquid used.

### Example 2.4

### In Face of Trichomonas vaginalis Isolated of Vaginitis

03 strains of the protozoan isolated were used from patients with vaginitis assisted in ambulatory services.

The results show that the minimum inhibitory concentration employed in the ratio of 10 mg of the C. nardus extract for 1 ml of diluent, varied from 0.6-1.25 mg/ml of the liquid medium total. In agreement with the results of the biological activity, these prove that the C. nardus extract presents excellent performance in tests in vitro in face of isolated Trichomonas vaginalis of human clinical presentations. And that activity is trichomonicid, starting from 625 μg/ml, while smaller amounts varying from 10 μg/ml up to 320 μg/ml the extract provoked death of the protozoa being dependent dose, according to Table 6.

TABLE 6
Determination of the minimum inhibitory concentration
of the C. nardus extract capable to inhibit
the growth of Trichomonas vaginalis

| Tubes | mg/ml | Extract - strain CAR | |
|---|---|---|---|
| 1 | 5.0 | — | |
| 2 | 2.5 | — | |
| 3 | 1.25 | — | |
| 4 | 0.625 | — | |
| 5 | 0.320 | 5 × 10³ | cel/ml |
| 6 | 0.15 | 7.75 × 10⁴ | cel/ml |
| 7 | 0.07 | 5.25 × 10⁴ | cel/ml |
| 8 | 0.04 | 9.25 × 10⁴ | cel/ml |
| 9 | 0.02 | 1.275 × 10⁵ | cel/ml |
| 10 | 0.01 | 2.275 × 10⁵ | cel/ml |
| C+ | | 2.575 × 10⁵ | cel/ml |

In accordance with the results of the biological activity, these prove that the C. nardus extract presents excellent performance in tests in vitro inface of isolated Trichomonas vaginalis from human clinical presentations. And that activity is trichomonicide, starting from 625 μg/ml, while smaller amounts varying from 10 μg/ml up to 320 μg/ml the extract provoked death of the protozoa being dose-dependent.

### Example 3

### Optimization of the Extraction

Extracts were obtained using three dilutions of ethyl alcohol 50, 70 and 94.6% (p/p) and containing concentrations of C. nardus between 10, 20 and 30% (p/p). The extracts were filtered, concentrated in rotary evaporator and later lyophylized. They were submitted to the determination of the dry residual and antimicrobial evaluation for the optimization of the extraction. For the accompanying of the extractive process the following parameters were established: values of pH in aqueous solution 1%, organoleptic characteristics (color, odor and taste), dry residual, tenor of active substances and chromatography over thin layer (CCD).

The results of dry residual are contained in Tables 7 and 8.

TABLE 7
Values obtained from dry residual (RS) from the
extracts of C. nardus (n = 12) fresh leaves

| Condition | Parameter | | |
|---|---|---|---|
| of Extraction | RS (%) | s | CV % |
| Alcohol 50%-10% of | 1.40 | 0.0251 | 1.80 |
| vegetal start material | | | |
| Alcohol 70%-10% of | 1.32 | 0.0623 | 4.71 |
| vegetal start material | | | |
| Alcohol 94.6%-10% of | 1.13 | 0.0335 | 2.97 |
| start material | | | |
| Alcohol 50%-10% of | 0.58 | 0.0208 | 3.59 |
| vegetal start material | | | |
| Alcohol 50%-20% of | 1.05 | 0.0392 | 3.73 |
| vegetal start material | | | |
| Alcohol 50%-30% of | 1.59 | 0.0707 | 4.45 |
| vegetal start material | | | |

TABLE 8
Values obtained of dry residual (RS) of the producer in
comparison with the nursery of UEM (n = 9), dry leaves

| Parameter | RS | s | CV % |
|---|---|---|---|
| Nursery | 1.92 | 0.0842 | 4.39 |
| Producer | 1.98 | 0.0299 | 1.58 |

Obs: S = standard deviation and CV % = coefficient of variance

For proof of the best extract all were submitted to the evaluation of the antifungal activity. The same experiment was done varying fresh and dry leaves and between producers. The results are contained in Table 8. This process of optimization versus antifungal activity showed that the hydro-alcoholic extractor liquids in the dilutions 50, 70 and 94.6% (w/w) presented themselves as adequate in the obtaining of the extract of C. nardus and did not interfere in its anti-fungicidal activity, in vitro, in face of the isolated yeasts of the patients and the standard yeast (ATCC). The preferred concentrations of plant; the best response was between 10 and 20% (p/p).

TABLE 9
Variation of the Minimum inhibitory concentration (CIM) and Minimum
fungicidal concentration (CFM) in mg/ml of the extracts of C. nardus
over yeasts (C. Albicans and C. tropicalis)

| | | CIM - | CFM - |
|---|---|---|---|
| | | Interval | Interval |
| Extract | Yeasts | mg/ml | mg/ml |
| Alcohol 50% (p/p) | Genus | 0.039-0.156 | 0.039-0.156 |
| 10% C. nardus | Candida | | |
| Alcohol 50% (p/p) | Genus | 0.312-0.156 | 0.312-0.156 |
| 20% C. nardus | Candida | | |
| Alcohol 50% (p/p) | Genus | 0.312-1.25 | 0.312-1.25 |
| 30% C. nardus | Candida | | |
| Alcohol 50% (p/p) | Genus | 0.62-1.25 | 0.6-1.25 |
| 10% vegetal | Candida | | |
| start material | | | |
| Alcohol 70% (p/p) | Genus | 0.62-1.25 | 0.62-1.25 |
| 10% vegetal start | Candida | | |
| material | | | |
| Alcohol 94.6% | Genus | 0.62-1.25 | 0.62-1.25 |
| (p/p) | Candida | | |
| 10% vegetal start | | | |
| material | | | |

The examples presented above are not limitative of the technique and methodology used in the obtaining and preparation of the hydro-alcoholic and dry extracts of the present invention, employed as active antifungal agents in the preparation of pharmaceutical compositions that can be presented in the liquid, gel, ointment, cream, oval, capsules and tablet forms for oral or local use as well as for topical use, useful in the combat of onychomycosis, dermatomycosis and candidiasis and in the parasitoses as in the trichomoniasis.

1. An antifungal and trichomonicidal pharmaceutical composition comprising a hydro-alcoholic vegetal extract of Cymbopogon nardus in the concentrations from 0.1 to 40′ (w/w) and at least a hydro-alcoholic solvent having from 1 to 10 carbon atoms.

2. The antifungal and trichomonicidal pharmaceutical composition of claim 17, comprising the hydro-alcoholic vegetal extract of Cymbopogon nardus in the concentrations from 5 to 40% (w/w).

3. The pharmaceutical composition according to claim 17 in which the hydro-alcoholic solvent is ethanol or dipropylene glycol.

4. The pharmaceutical composition according to claim 19 in which the hydroalcoholic solvent is dipropylene glycol that is present in the proportion from 0.1 to 20 ml to each 10 mg of dry extract.

5. The pharmaceutical composition according to claim 19 in which the hydro-alcoholic solvent is ethanol that is diluted in water in the range from 20 to 96% (v/v) and containing 0.1 to 30% of dry extract.

6. A method for treating a fungal infection comprising administering the composition of claim 17 to a patient infected by Mycrosporum canis, Mycrosporum ferrugineum, Mycrosporum gypseum, Trichophytum mentagrophytes, Trichophytum raubistscheki, Trichosporum tonsurans, Candida albicans, Candida glabrata, Candida parapsilosis or Candida tropicalis.

7. A method for treating Trichomonas vaginalis comprising administering the composition of claim 17 to a patient infected by Trichomonas vaginalis.

8. A process for obtaining dry extracts from the leaves of Cymbopogon nardus comprising:
a. Breaking down the vegetal tissues in a solvent comprising an alcoholic organic solvent containing between 1 to 6 carbon atoms and water;
b. Concentrating the extract by evaporating the organic solvent at a temperature from 35 to 45° C. and at reduced pressure near vacuum; and
c. Lyophilizing the concentrated extract to obtain a dried extract.

9. The process according to claim 24 in which the organic solvent of step (a) is an alcoholic organic solvent having from 1 to 6 carbon atoms.

10. The process according to claim 25 in which the solvent is selected from the group consisting of ethanol, isopropanol, butanol, and pentanol.

11. The process according to claim 24 in which the concentration of the solvent is 50, 70 or 94.6% (w/w) in water.

12. An antifungal and trichomonicid pharmaceutical composition comprising a pharmaceutically acceptable carrier and Cympobogon nardus dry extract in the concentration from 0.6 to 1.25 mg/ml of the total weight of the composition.
